(19) United States
(12) Patent Application Publication
(10) Pub. No.: US 2018/0183198 A1
(43) Pub. Date: Jun. 28, 2018

(54) Crimp Indentor, Crimping Tool and Method of Producing a Crimp Indentor

(71) Applicant: TE Connectivity Germany GmbH, Bensheim (DE)

(72) Inventors: Guenter Sowa, Nieder-Olm (DE); Gerd Stegmayer, Rierstadt (DE); Michael Gerst, Worms (DE); Lothar Bauer, Wiesbaden (DE)

(73) Assignee: TE Connectivity Germany GmbH, Bensheim (DE)

(21) Appl. No.: 15/904,816

(22) Filed: Feb. 26, 2018

Related U.S. Application Data
(63) Continuation of application No. PCT/EP2016/070183, filed on Aug. 26, 2016.

(30) Foreign Application Priority Data
Aug. 27, 2015 (DE) 10 2015 114 290.2

(51) Int. Cl. H01R 43/048; H01R 43/058

(52) U.S. Cl. CPC H01R 43/048; H01R 43/058

(57) ABSTRACT

A crimp indentor for producing a crimp connection between an electrical conductor and a contact comprises a base and a machining portion connected to the base. The machining portion has a ceramic surface on at least a part of the machining portion. The machining portion is configured to transmit crimping forces to the contact while producing the crimp connection.

### CROSS-REFERENCE TO RELATED APPLICATIONS

This application is a continuation of PCT International Application No. PCT/EP2016/070183, filed on Aug. 26, 2016, which claims priority under 35 U.S.C. § 119 to German Patent Application No. 102015114290.2, filed on Aug. 27, 2015.

### FIELD OF THE INVENTION

The present invention relates to a crimp indentor and, more particularly, to a crimp indentor for producing a crimp connection between an electrical conductor and a contact.

### BACKGROUND

During crimping of contacts to electrical conductors/electric cables, a piece of metal is mechanically deformed to produce an electrical and/or mechanical connection. Crimp connections are used extensively to attach electrical contacts and connectors to cables. It is common for metal lugs of a contact to be deformed in a pressing device such that they enclose and firmly clamp an insulation casing or a stripped conductor.

For the mechanical production of such crimp connections, crimping devices are used in which a portion of a cable and corresponding crimping lugs are positioned between a crimp indentor and a crimp anvil. Bringing the crimp indentor and the crimp anvil together deforms the crimping lugs around the cable and crimps the lugs to the cable, forming an electrical connection between the contact and the conductor. At the end of the crimping operation, the crimping lug has an outer contour in the crimping region in the form of the contour of the crimp indentor.

Known crimp indentors have a base on which a machining portion of the crimp indentor is fitted and a corresponding crimping tool. The machining portion contacts the crimping tool and forms the crimp connection. To produce a precise and firm crimp connection, such crimp indentors must meet stringent dimensional requirements and must be capable of absorbing considerable forces in the respective machining ranges during the crimping operation. Crimp indentors consequently are commonly produced from high-alloy, abrasion-resistant and wear-resistant tool steel. Although such crimp indentors exhibit good properties during use, they are nevertheless relatively complex and expensive to produce since the crimp indentors have to be subsequently hardened, polished and chrome-plated, and reworked following the chrome-plating operation. Such highly precise machining is time-consuming and costly. Crimp indentors cannot currently be produced in a fully automated and efficient manner.

### SUMMARY

A crimp indentor for producing a crimp connection between an electrical conductor and a contact comprises a base and a machining portion connected to the base. The machining portion has a ceramic surface on at least a part of the machining portion. The machining portion is configured to transmit crimping forces to the contact while producing the crimp connection.

### BRIEF DESCRIPTION OF THE DRAWINGS

The invention will now be described by way of example with reference to the accompanying Figures, of which:

FIG. 1 is a perspective view of a crimp indentor according to an embodiment;

FIG. 2 is a detail perspective view of the crimp indentor of FIG. 1;

FIG. 3 is a perspective view of a crimp indentor according to another embodiment;

FIG. 4 is a detail perspective view of the crimp indentor of FIG. 3; and

FIG. 5 is a perspective view of a crimp indentor according to another embodiment.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will be thorough and complete and will fully convey the concept of the disclosure to those skilled in the art.

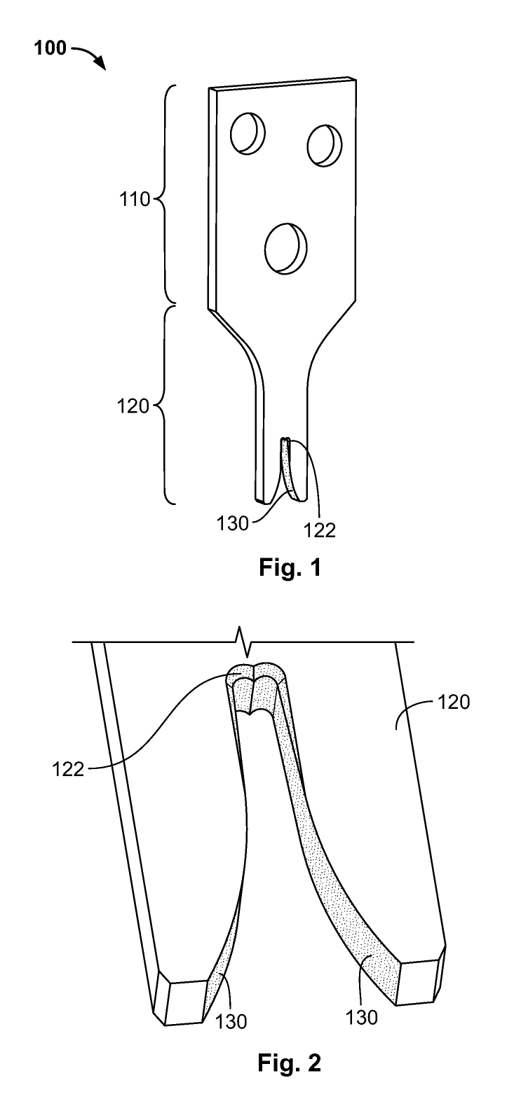

A crimp indentor 100 according to an embodiment is shown in FIGS. 1 and 2. The crimp indentor 100 is used to produce a crimp connection between an electrical conductor and a contact. The crimp indentor 100 includes a base 110 and a machining portion 120. The crimp indentor 100 is cut out of a crimp indentor blank; the crimp indentor blank may be formed of various material in various embodiments.

The crimp indentor 100 is fixed and retained on a crimping tool head at the base 110 of the crimp indentor 100. The machining portion 120, shown in FIG. 2, is configured to transmit crimping forces to the contact during the production of the crimp connection. At least a portion of the machining portion 120 has a ceramic surface. The ceramic surface is disposed on the machining portion 120 in such a manner that the crimping forces occurring during the production of the crimp connection are transmitted to the contact via the ceramic surface.

The machining portion 120 or the ceramic surface of the machining portion 120 can be formed with a plurality of different indentor contours in various embodiments. The indentor contour has a three-dimensionally curved surface 122, as shown in FIGS. 1 and 2. In the embodiment shown in FIG. 2, the curved surface 122 is shaped to produce a B-crimp connection.

To form a crimp connection, an electrical conductor is disposed between the machining portion 120 of the crimp indentor 100 and a crimp anvil. A contact is positioned on the electrical conductor. The crimp indentor 100 and the crimp anvil are then brought together; the crimp anvil is configured to push the electrical conductor and the contact against the crimp indentor 100 and generate crimping forces between the crimp indentor 100 and the contact. The crimping forces plastically deform the contact and the electrical conductor is thereby surrounded by the contact. Between the crimp anvil and the three dimensionally curved surface 122 of the indentor contour, the contact is pushed together in order to produce a reliable mechanical and electrical contact around the electrical conductor.

In the embodiment shown in FIGS. 1 and 2, the ceramic surface has been applied to the machining portion 120 in the form of a coating 130. In a further embodiment, the coating 130 is a sintered coating 130.

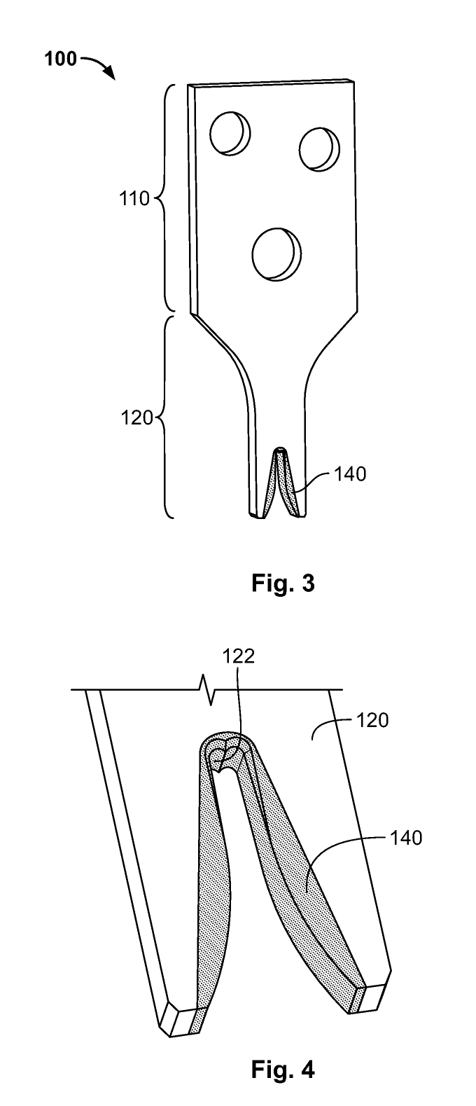

A crimp indentor 100 according to another embodiment of the invention is shown in FIGS. 3 and 4. In the embodiment shown in FIGS. 3 and 4, the machining portion 120 has an insert 140 which is connected to the machining portion 120 of the crimp indentor 100. The insert 140 consists of a ceramic material and the ceramic surface of the machining portion 120 is an outer surface of the insert 140 in this embodiment.

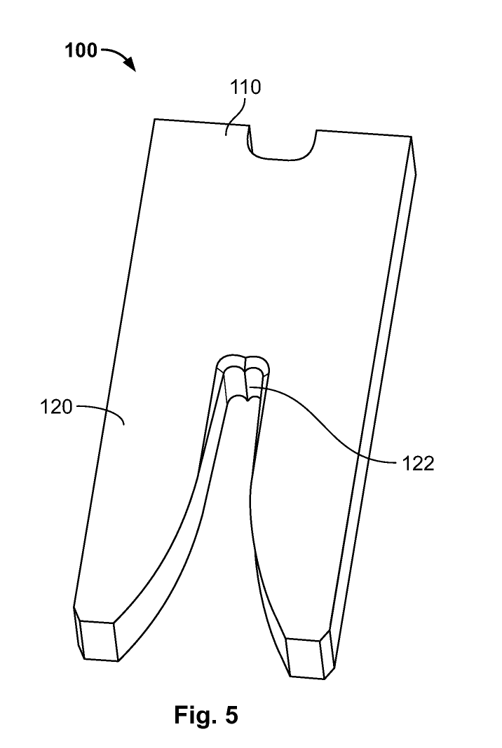

A crimp indentor 100 according to another embodiment of the invention is shown in FIG. 5. In the embodiment shown in FIG. 5, the base 110 and the machining portion 120 are monolithically formed as a single-piece crimp indentor 100. The single-piece crimp indentor 100 consists of a ceramic material and is cut from a ceramic blank.

The crimp indentors 100 must have a sufficient strength and hardness to allow them to maintain precise dimensions even following a large number of crimp connections carried out under high levels of force. A material and finish of the machining portion 120 is important because frictional forces between the contact and the crimp indentor 100 should be minimized. Accordingly, a smooth surface finish of the ceramic surface results in a reduction in the co-efficient of friction and thus in a higher quality of the crimp connection, without any need for the use of additional lubricants. Using the ceramic surface results in the crimp indentor 100 being burr-free in the machining portion 120. It is thus possible to process even difficult-to-crimp materials, for example stainless steel, and to achieve a longer service life for the crimp indentor 100 without the need for additional plating on the machining portion 120. Further, for a machining portion 120 with a ceramic surface or a single-piece crimp indentor 100 made of ceramic material, fully automated production is possible which is more cost-effective and provides higher quality than previous production methods.

What is claimed is:

1. A crimp indentor for producing a crimp connection between an electrical conductor and a contact, comprising:
a base; and
a machining portion connected to the base and having a ceramic surface on at least a part of the machining portion, the machining portion configured to transmit crimping forces to the contact while producing the crimp connection.

2. The crimp indentor of claim 1, wherein the ceramic surface contacts the contact and the crimping forces are transmitted to the contact via the ceramic surface.

3. The crimp indentor of claim 1, wherein the ceramic surface is a ceramic coating.

4. The crimp indentor of claim 3, wherein the ceramic coating is a sintered coating.

5. The crimp indentor of claim 1, further comprising an insert connected to the machining portion, the insert consisting of a ceramic material and forming the ceramic surface.

6. The crimp indentor of claim 1, wherein the base and the machining portion are monolithically formed in a single piece.

7. The crimp indentor of claim 6, wherein the base and machining portion consist of a ceramic material.

8. The crimp indentor of claim 1, wherein the ceramic surface is a three-dimensionally curved surface.

9. The crimp indentor of claim 8, wherein the curved surface is shaped to produce a B-crimp connection.

10. A crimping tool for producing a crimp connection between an electrical conductor and a contact, comprising:
a crimp indentor including a base and a machining portion connected to the base, the machining portion having a ceramic surface on at least a part of the machining portion; and
a crimp anvil configured to push the electrical conductor and the contact against the crimp indentor and generate crimping forces between the crimp indentor and the contact, the machining portion configured to transmit the crimping forces to the contact and plastically deform the contact while producing the crimp connection.

11. A method of producing a crimp indentor configured to form a crimp connection between an electrical conductor and a contact, the method comprising the steps of:
providing a crimp indentor blank; and
cutting the crimp indentor blank to form a base and a machining portion connected to the base, the machining portion having a ceramic surface on at least a part of the machining portion contacting the contact and configured to transmit crimping forces to the contact while producing the crimp connection.

12. The method of claim 11, further comprising applying a ceramic coating to the machining portion to form the ceramic surface.

13. The method of claim 12, wherein the ceramic coating is a sintered coating.

14. The method of claim 11, wherein the machining portion has an insert connected to the machining portion, the insert consisting of a ceramic material and forming the ceramic surface.

15. The method of claim 11, wherein the base and the machining portion are monolithically formed in a single piece.

16. The method of claim 15, wherein the crimp indentor blank is a ceramic material.
